(19) United States
(12) Patent Application Publication
(10) Pub. No.: US 2021/0027632 A1
(43) Pub. Date: Jan. 28, 2021

(54) VEHICLE DISPATCH APPARATUS, VEHICLE DISPATCH SYSTEM AND VEHICLE DISPATCH METHOD

(71) Applicant: Honda Motor Co., Ltd., Tokyo (JP)

(72) Inventors: Masahiro Ise, Wako-shi (JP); Tsubasa Uchida, Wako-Shi (JP); Masako Komaki, Wako-shi (JP); Masato Naito, Nagoya-shi (JP)

(21) Appl. No.: 16/933,781

(22) Filed: Jul. 20, 2020

(30) Foreign Application Priority Data
Jul. 22, 2019 (JP) 2019-134287

(51) Int. Cl. G08G 1/00; G01C 21/34; G06Q 50/30; G06Q 10/06

(52) U.S. Cl. CPC G08G 1/202; G01C 21/3453; G06Q 50/14; G06Q 10/06315; G06Q 50/30

(57) ABSTRACT

A vehicle dispatch apparatus configured to execute vehicle dispatch for a user in response to a travel instruction from a first point to a second point instructed by the user, includes: an electronic control unit having a CPU and a memory. The CPU is configured to perform: acquiring a destination information about a destination corresponding to the second point; acquiring a driver information about a driver owning a vehicle associated with an area including the destination based on the destination information acquired; and instructing dispatch of the vehicle associated with the area to the first point based on the driver information acquired.

### CROSS-REFERENCE TO RELATED APPLICATION

This application is based upon and claims the benefit of priority from Japanese Patent Application No. 2019-134287 filed on Jul. 22, 2019, the content of which is incorporated herein by reference.

### BACKGROUND OF THE INVENTION

### Field of the Invention

This invention relates to a vehicle dispatch apparatus and a vehicle dispatch system.

### Description of the Related Art

Conventionally, there has been known a device for carrying out a vehicle dispatch of a taxi. This device is described in, for example, Japanese Unexamined Patent Application Publication No. 2019-091274 (JP2019-091274A). The device according to JP2019-091274A is configured to carry out dispatching of the taxi on the basis of the demand forecasts of the taxi users.

Incidentally, when the user travels from a departure point such as a station or an airport to a destination, the user often rides on a vehicle such as a taxi waiting at the departure point and travels to the destination. However, rather than using a vehicle such as a taxi associated with a departure point, it may be preferable to use a vehicle associated with a destination to travel to the destination.

### SUMMARY OF THE INVENTION

An aspect of the present invention is a vehicle dispatch apparatus configured to execute vehicle dispatch for a user in response to a travel instruction from a first point to a second point instructed by the user. The vehicle dispatch apparatus includes: an electronic control unit having a CPU and a memory. The CPU is configured to perform: acquiring a destination information about a destination corresponding to the second point; acquiring a driver information about a driver owning a vehicle associated with an area including the destination based on the destination information acquired; and instructing dispatch of the vehicle associated with the area to the first point based on the driver information acquired.

Another aspect of the present invention is a vehicle dispatch system. The vehicle dispatch system includes: the vehicle dispatch apparatus; a driver terminal carried by a driver or mounted on a vehicle owned by the driver and configured to be able to communicate with the vehicle dispatch apparatus; and a user terminal carried by a user and configured to be able to communicate with the vehicle dispatch apparatus to input a travel instruction from the first point to the second point.

Another aspect of the present invention is a vehicle dispatch method for executing vehicle dispatch for a user in response to a travel instruction from a first point to a second point instructed by the user. The vehicle dispatch method includes: acquiring a destination information about a destination corresponding to the second point; acquiring a driver information about a driver owning a vehicle associated with an area including the destination based on the destination information acquired; and instructing dispatch of the vehicle associated with the area to the first point based on the driver information acquired.

### BRIEF DESCRIPTION OF THE DRAWINGS

The objects, features, and advantages of the present invention will become clearer from the following description of embodiments in relation to the attached drawings, in which:

FIG. 1 is a drawing illustrating a vehicle dispatch service which is an application example of a vehicle dispatch apparatus according to an embodiment of the present invention;

FIG. 2 is a diagram showing a schematic configuration of a ride share system to which a vehicle dispatch apparatus according to the embodiment of the present invention is applied;

FIG. 3 is a block diagram showing a configuration of a main part of the ride share system of FIG. 2;

FIG. 4 is a block diagram showing a configuration of a main part of a server device of FIG. 3; and

FIG. 5 is a flowchart showing an example of processing performed by an arithmetic unit of the server device of FIG. 4.

### DETAILED DESCRIPTION OF THE INVENTION

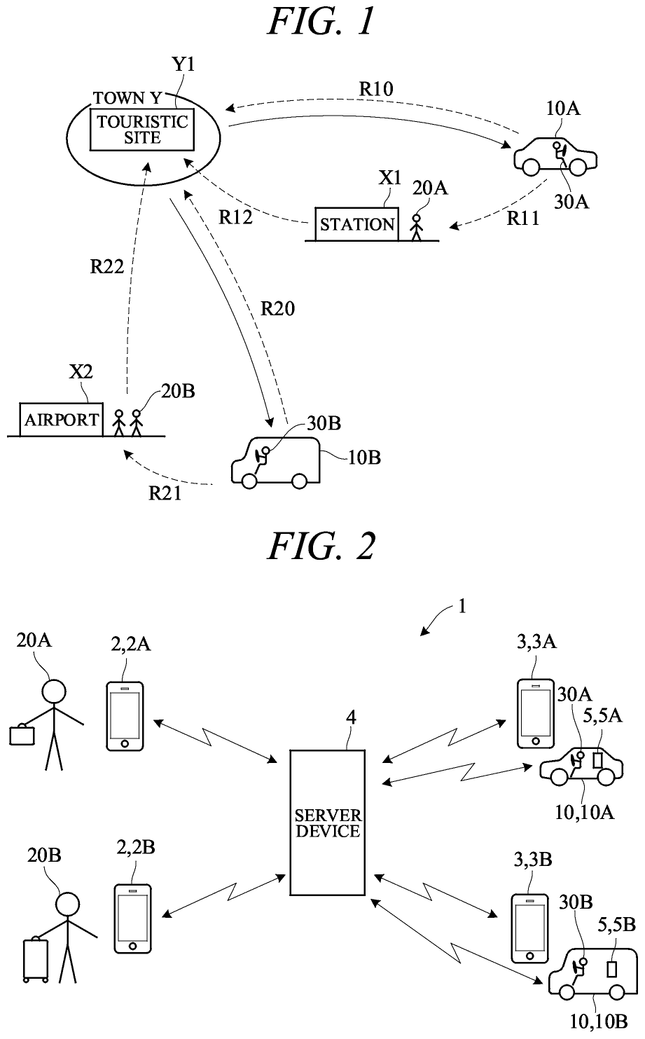

Hereinafter, an embodiment of the present invention will be described with reference to FIGS. 1 to 5. FIG. 1 is a diagram illustrating a vehicle dispatch service which is an application example of a vehicle dispatch apparatus according to an embodiment of the present invention. The vehicle dispatch service is used when the user travels to a destination from a station, an airport, or the like. FIG. 1 shows an example in which a user 20A travels from a station X1 to a touristic site Y1 in a town Y, and an example in which a user 20B travels from an airport X2 to a touristic site Y1. The user 20A rides on the vehicle 10A driven by a driver 30A, and the user 20B rides on the vehicle 10B driven by a driver 30B.

The drivers 30A and 30B are drivers (local drivers) that reside in the area to which the touristic site Y1 belongs. Driver 30A picks up the user 20A at the station X1 and transports the user 20A to the touristic site Y1 on the way back. That is, the vehicle 10A transports the user 20A to the tourist spot Y1 through routes R11 and R12. The driver 30B picks up the user 20B at the airport X2 and transports the user 20B to the touristic site Y1 on the way back. That is, the vehicle 10B transports the user 20B to the touristic site Y1 through routes R21 and R22. At this time, a consideration for transportation is paid from the users 20A and 20B to the drivers 30A and 30B. In FIG. 1, a route R10 in which the vehicle 10A reaches the town Y without passing through the position of the user 20A and a route R20 in which the vehicle 10B reaches the town Y without passing through the position of the user 20B are also shown.

As entities that provide such vehicle dispatch services, in addition to taxi companies, there are also entities that provide ride share services. A ride share service is a service that establishes a match between a driver that provides ride shares and a user who wants ride shares. Ride share is a generic term for social services that matches the demand and supply of carpool, and carpool refers to multiple people getting together on a single vehicle.

In the following, an example will be described in which a ride share service is used as a vehicle dispatch service for supporting the establishment of matching between the local drivers 30A and 30B providing ride share and the users 20A and 20B desiring ride share, and for executing the vehicle dispatch to the users.

FIG. 2 is a diagram showing a schematic configuration of a ride share system 1 to which a vehicle dispatch apparatus according to the embodiment of the present invention is applied. The vehicle dispatch apparatus according to the present embodiment is configured by, for example, the server device 4. As shown in FIG. 2, the ride share system 1 includes a user terminal 2 owned by a user, a driver terminal 3 owned by a local driver, an in-vehicle terminal 5 mounted on a vehicle 10 driven by the local driver, and a server device 4. The user terminal 2 and the driver terminal 3 are configured by a portable terminal such as a smart phone.

In FIG. 2, for convenience, two user terminals 2 (2A, 2B), two driver terminals 3 (3A, 3B), two vehicles 10 (10A, 10B) and two in-vehicle terminal 5 (5A, 5B), the number of the user terminal 2, the driver terminal 3 and the vehicle 10 (in-vehicle terminal 5) is not limited to that of FIG. 2.

The users 20A and 20B are persons who have registered necessary information in advance in a business entity that provides a ride share service (ride share business). The terminal used for utilizing the ride share may be a terminal dedicated to the ride share, but the user terminal 2 owned by the user himself or herself is preferable.

The local drivers 30A and 30B are persons who have registered necessary information in advance in the business entity that provides the ride share service. The terminal used for providing the ride share may be a terminal dedicated to the ride share, but the driver terminal 3 owned by the local driver himself or herself is suitable. Instead of the driver terminal 3, it is also possible to use the in-vehicle terminal 5 mounted on the vehicle 10.

The vehicle 10 is a vehicle which has registered necessary information in advance in the business entity that provides a ride share service. The in-vehicle terminal 5 is mounted on the vehicle 10. The vehicle 10 may be a special vehicle type for the ride share, but a private vehicle owned by the local drivers 30A and 30B is preferable. Private vehicles owned by local drivers 30A and 30B include various types of four-wheeled vehicles with different car sizes (body size, luggage compartment capacity, etc.) such as sedans, minivans, one-box cars, wagons, trucks, etc. The inclusion of various types of vehicles increases the user's choice of vehicles and improves ride share convenience.

Incidentally, the ride share is generally configured such that, when a user requests a vehicle dispatch using a portable wireless terminal such as a smart phone, the current position of the portable wireless terminal and the vehicle driven by the driver providing the ride share is input through the GPS function, and the driver running near the position of the user is called.

On the other hand, in rural areas, since the absolute number of drivers providing ride share is small, it is difficult to use ride share, and it is common to use taxis. However, passenger transportation using a vehicle such as a taxi is used from a landing (departure point) at a station, an airport, or the like, and often has a service office in the vicinity thereof. Therefore, an increase in tax revenue of the local government due to an increase in sales of taxi companies will improve the economy of the area to which the place of departure belongs. On the other hand, the economy of the area to which the destination belongs is not as improved as the economy of the area to which the departure place belongs.

In consideration of this point, the present embodiment is configured so that the user can be transported to the destination by the local driver of the region to which the destination belongs. As the income of the local drivers increases, the tax revenue of the area increases, so that the economy of the area in which the destination belongs will be benefited. Since the user goes to the destination riding on a vehicle driven by a local driver who is familiar with the traffic situation around the destination, the user can obtain a sense of security and can obtain useful information about the region through conversation with the local driver until he/she arrives at the destination. For example, useful information on touristic sites and useful information on restaurants in the area can be obtained. Users can communicate with local residents, and satisfaction is improved.

In order to satisfactorily realize the provision of such ride share services, the present embodiment constitutes a vehicle dispatch apparatus as follows.

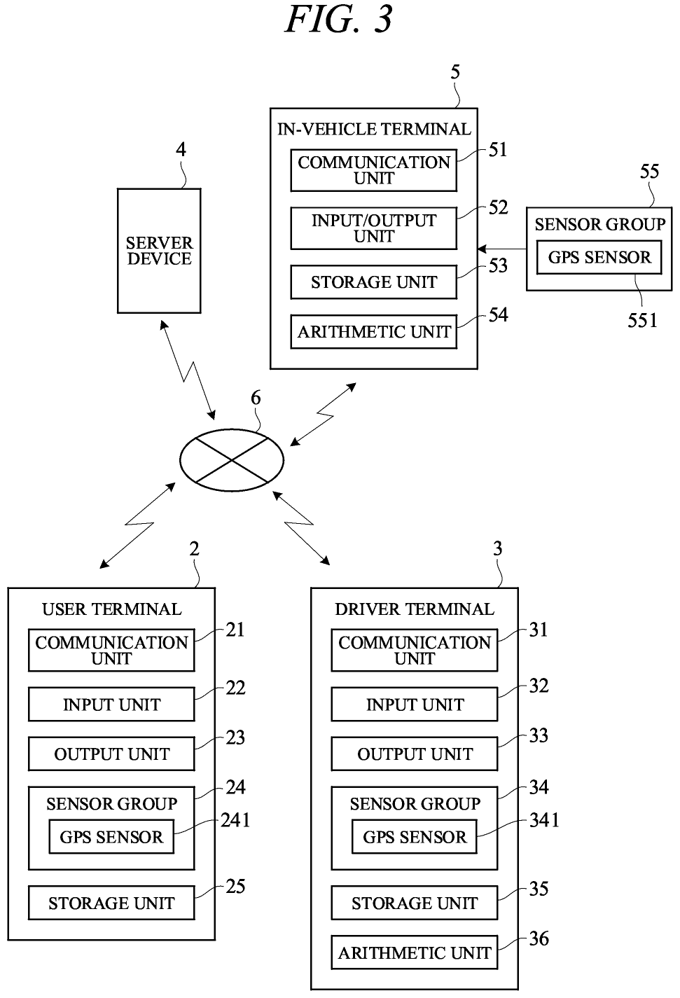

FIG. 3 is a block diagram showing a configuration of a main part of the ride share system 1 of FIG. 2. As illustrated in FIG. 3, the user terminal 2, the driver terminal 3, the in-vehicle terminal 5, and the server device 4 are respectively connected to a communication network 6 such as a wireless communication network, an Internet communication network, and a telephone line network. In FIG. 3, for convenience, although the user terminal 2, the driver terminal 3 and the in-vehicle terminal 5 are shown one by one respectively, these are actually provided a plurality (see FIG. 2). In FIG. 3, a single server device 4 is shown, but the functions of the server device 4 may be distributed among a plurality of server devices.

The user terminal 2 is composed of a portable wireless terminal such as a smart phone. The user terminal 2 may be configured by a personal computer operated by a user. As shown in FIG. 3, the user terminal 2 includes a communication unit 21, an input unit 22, an output unit 23, a sensor group 24, a storage unit 25, and an arithmetic unit 26.

The communication unit 21 is configured to be capable of wireless communication with the server device 4, the driver terminal 3, and the in-vehicle terminal 5 through the communication network 6. The input unit 22 includes various switch buttons (such as a touch panel) that can be operated by a user and a microphone that can input sound. The output unit 23 includes a monitor capable of displaying images and the like, a speaker capable of outputting sound, and the like.

The user inputs user information through the input unit 22 and confirms the inputted user information through the output unit 23. The user information includes an address, a name, a contact address, and information necessary for settlement (e.g., a credit card number). When the user enters the user information and the membership registration is made, the user ID is issued, which enables the use of the ride shares.

When the ride share is used, use information is input by the user through the input unit 22. The use information includes destination information of the ride share. The destination information includes information for specifying a destination such as a name, an address, and a telephone number of the destination. When an application for use of ride share is made in advance, use information such as the date and time of use of ride share, departure place information, and destination information is input by the user as use information. The use information can be input using, for example, a dedicated application software used at the time of membership registration.

The sensor group 24 includes various sensors for detecting the state of the user terminal 2. The sensor group 24 includes, by way of example, a GPS sensor 241 that receives signals from GPS satellites to detect the position of user terminal 2. Although not shown, a battery sensor for detecting the remaining capacity of the battery, a receiving sensor for detecting the reception status of radio waves, and the like are also included in the sensor group 24. The server device 4 receives the position information of the user terminal 2 detected by the GPS sensor 241, and thereby detects the position information of the user.

The storage unit 25 has a volatile or non-volatile memory, and the storage unit 25 stores various programs to be executed by the arithmetic unit 26 and various data. The storage unit 25 stores, for example, map information used for detecting the position information of the user terminal 2. The storage unit 25 temporarily stores data input through the input unit 22, detection data (e.g., position information of the user) by the sensor group 24, and the like.

The arithmetic unit 26 has a CPU, executes predetermined processing based on a signal input through the input unit 22, a signal detected by the sensor group 24, a signal received from the outside of the user terminal 2 through the communication unit 21, a program, data, and the like stored in the storage unit 25, and outputs control signals to the communication unit 21, the output unit 23, and the storage unit 25. Thus, it is possible to transmit the user position information and the use information including the destination information input by the user to the server device 4. The user can confirm the establishment of the ride share matching and acquire the position information of the local driver through the input unit 22 and the output unit 23. The driver terminal 3 is composed of a portable wireless terminal such as a smart phone. The driver terminal 3 may be configured by a personal computer operated by a local driver. As shown in FIG. 3, the driver terminal 3 includes a communication unit 31, an input unit 32, an output unit 33, a sensor group 34, a storage unit 35, and an arithmetic unit 36.

The communication unit 31 is configured to be capable of wireless communication with the server device 4, the user terminal 2, and the in-vehicle terminal 5 through the communication network 6. The input unit 32 includes various switch buttons (such as a touch panel) operable by a local driver and a microphone capable of inputting sound. The output unit 33 includes a monitor capable of displaying images and the like, a speaker capable of outputting sound, and the like.

The local driver inputs driver information through the input unit 32 and confirms the inputted driver information through the output unit 33. The driver information includes an address, a name, a contact address, a license number, vehicle information of a vehicle owned by the local driver, and the like. The vehicle information includes vehicle type, year model, car body number, vehicle number, travel distance and parking lot information, etc. The local driver is assigned a driver ID after inputting the driver information and registered as a member, and then becomes able to provide the ride share.

When there is an application for use of ride share from the user, the local driver outputs whether or not the ride share is can be provided (accepted or not accepted) to the server device 4 through the driver terminal 3 based on the position information and the destination information of the user transmitted from the server device 4. The position information and the destination information of the user transmitted from the server device 4 are output to an output unit (for example, displayed on a monitor) of the driver terminal 3. The information and the availability of the ride share can be input using, for example, a dedicated application software used at the time of membership registration. When the local driver accepts the ride share through the driver terminal 3 and a match is established between the local driver and the user, the server device 4 transmits to the driver terminal 3 an instruction (vehicle pickup instruction) for traveling toward the point (departure point) instructed by the user.

The sensor group 34 includes various sensors for detecting the state of the driver terminal 3. The sensor group 34, as an example, has a GPS sensor 341 for detecting the position of the driver terminal 3 by receiving a signal from the GPS satellite. Although not shown, a battery sensor for detecting the remaining capacity of the battery, a receiving sensor for detecting the reception status of radio waves, and the like are also included in the sensor group 34. The server device 4 receives the position information of the driver terminal 3 detected by the GPS sensor 341, and thereby detects the position information of the local driver.

The storage unit 35 has a volatile or non-volatile memory, and the storage unit 35 stores various programs to be executed by the arithmetic unit 36 and various data. The storage unit 35 stores, for example, map information used for detecting the position information of the driver terminal 3. The storage unit 35 temporarily stores data input through the input unit 32, detection data by the sensor group 34, for example, position information of a local driver, and the like.

The arithmetic unit 36 has a CPU, executes predetermined processing based on a signal input through the input unit 32, a signal detected by the sensor group 34, a signal received from the outside of the driver terminal 3 through the communication unit 31, a program, data, and the like stored in the storage unit 35, and outputs control signals to the communication unit 31, the output unit 33, and the storage unit 35. As a result, the position information of the local driver and the availability of the ride share input by the local driver can be transmitted to the server device 4. The local driver can confirm the establishment of the ride share matching and acquire the position information of the user through the input unit 32 and the output unit 33.

The in-vehicle terminal 5 is configured to include an on-board navigation device to be mounted on the vehicle. As shown in FIG. 3, the in-vehicle terminal 5 includes a communication unit 51, an input/output unit 52, a storage unit 53, and an arithmetic unit 54. The sensor group 55 is connected to the in-vehicle terminal 5. The communication unit 51 is configured to be capable of wireless communication with the server device 4, the user terminal 2, and the driver terminal 3 through the communication network 6. The input/output unit 52 includes various switches and buttons that can be operated by a local driver, a microphone, a speaker, a monitor, and the like. When an application for use of the ride share is made by the user, the local driver can also output whether or not the ride share is available to the server device 4 through the input/output unit 52. An instruction transmitted from the server device 4 to the driver terminal 3, for example, an instruction to pick up after matching is established, may be transmitted to the in-vehicle terminal 5.

The storage unit 53 has a volatile or non-volatile memory, the storage unit 53 stores various programs to be executed by the arithmetic unit 54 and various data. The storage unit 53 stores map information used for detecting position information of the vehicle 10, for example. The storage unit 53 temporarily stores data input through the input-output unit 52, the detection data by the sensor group 55 (e.g., position information of the vehicle 10), and the like.

The arithmetic unit 54 has a CPU, executes a predetermined process based on the signal input through the input-output unit 52, the signal detected by the sensor group 55, the signal received from the outside of the in-vehicle terminal 5 through the communication unit 51, the program and data stored in the storage unit 53, and the like, and outputs a control signal to each of the communication unit 51, the input-output unit 52 and the storage unit 53. As a result, the position information of the vehicle 10, the availability of the ride share input by the local driver, and the like can be transmitted to the server device 4. The local driver can confirm the establishment of the ride share matching or acquire the position information of the user through the input/output unit 52.

The sensor group 55 includes various sensors for detecting vehicle conditions. The sensor group 55, as an example, has a GPS sensor 551 for detecting the position of the in-vehicle terminal 5 (vehicle) by receiving a signal from the GPS satellite. Although not shown, a vehicle speed sensor for detecting a vehicle speed, an acceleration sensor for detecting an acceleration acting on the vehicle, a gyro sensor for detecting an angular velocity, a travel distance sensor for detecting a travel distance, a fuel detection sensor for detecting a remaining amount of fuel, a battery capacity detecting sensor for detecting a remaining capacity of the battery, and the like are also included in the sensor group 55.

The server device 4 is provided, for example, in a business entity that provides a ride share service. It can also be established in municipalities specified by administrative districts. Local governments can also be entities that provide ride-share services, which can effectively revitalize local communities. The server device 4 can also be configured using a virtual server function on the cloud service.

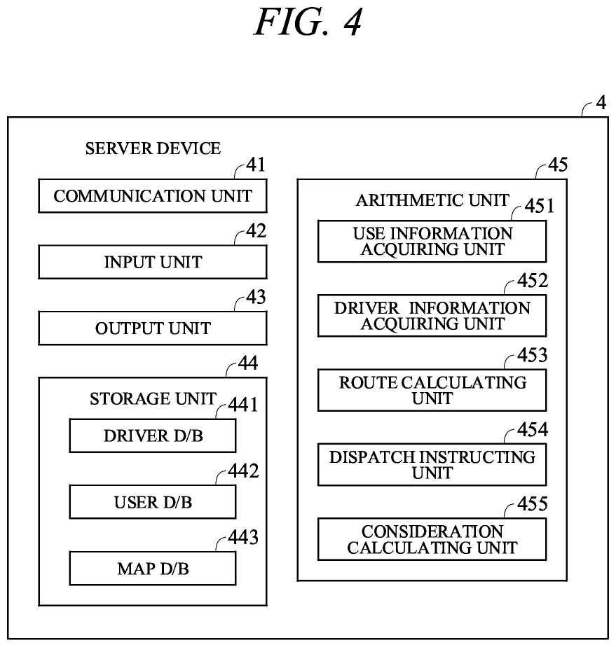

FIG. 4 is a block diagram showing a configuration of a main part of the server device 4. As shown in FIG. 4, the server device 4 includes a communication unit 41, an input unit 42, an output unit 43, a storage unit 44, and an arithmetic unit 45.

The communication unit 41 is configured to enable wireless communication with the user terminal 2, the driver terminal 3, and the in-vehicle terminal 5 through the communication network 6, as shown in FIG. 3. The input unit 42 includes various switch buttons (keyboard, mouse, touch panel, etc.) that can be operated by a provider that provides a ride share service, a microphone that can input voice, and the like. The output unit 43 includes a monitor capable of displaying images and the like, a speaker capable of outputting sound, and the like.

When a user makes an application to register a ride share, the server device 4 performs registration processing based on the user information transmitted from the user terminal 2 and transmits the user ID to the user terminal 2 through the communication unit 41. Similarly, when a member registration application of the ride share is received from the local driver, the server device 4 performs registration processing based on the driver information transmitted from the driver terminal 3, and transmits the driver ID to the driver terminal 3 through the communication unit 41.

The storage unit 44 has a volatile or non-volatile memory, the storage unit 44 stores various programs to be executed by the arithmetic unit 45 and various data. The storage unit 44 includes a driver database 441, a user database 442, and a map database 443 as a functional configuration carried out by the memory.

The driver database 441 stores a driver ID that is identification information of the local driver, driver information such as an address, a name, a contact, and a license number of the local driver input through the driver terminal 3, and trust information of the driver such as an accident history and a traffic violation history. The driver information also includes vehicle information (such as vehicle ID) about the vehicle used for ride share. The driver database 441 stores driver information, trust information of the driver, and the like in association with the driver ID.

The user database 442 stores the user ID which is the identification information of the user, the user's address, the name, the contact information, and the user information necessary for payment (e.g., a credit card number) input through the user terminal 2, and the trust information of the user such as the usage history and the payment status. The user database 442 stores user information, user trust information, and the like in association with the user ID.

The map database 443 stores map information. The map information is used for detecting position information of the user terminal 2, the driver terminal 3, and the in-vehicle terminal 5, searching for destination information, and the like.

The arithmetic unit 45 has a CPU, executes predetermined processing based on a signal input through the input unit 42, a signal received from the outside of the server device 4 through the communication unit 41, a program, data, and the like stored in the storage unit 44, and outputs control signals to the communication unit 41, the input unit 42, and the storage unit 44. Thus, registration processing and ID transmission processing of the user and the local driver are performed.

The arithmetic unit 45 includes a use information acquiring unit 451, a driver information acquiring unit 452, a route calculating unit 453, a dispatch instructing unit 454, and a consideration calculating unit 455 as functional configurations of the processor.

The use information acquiring unit 451 acquires the use information of the ride share by the user. The use information acquiring unit 451 acquires the use information input by the user through the input unit 22 and transmitted through the communication unit 21, through the communication unit 41. For example, the use information acquiring unit 451 acquires the usage date and time of the ride share, the information of the departure point (departure point information), and the information of the destination (destination information), which are input by the user at the time of application for use of the ride share, through the communication unit 41.

The current position of the user is detectable by the GPS sensor 241 of the user terminal 2. Therefore, in the case where the departure point is the current position of the user, input of departure point information by the user may be omitted, and the use information acquiring unit 451 may acquire the departure point information by acquiring a signal from the GPS sensor 241. With respect to the destination information, the use information acquiring unit 451 acquires the destination information input by the user at the time of the usage application or the destination information input by the user when the ride share is used.

The driver information acquiring unit 452 acquires driver information of a driver having a vehicle associated with an area to which the destination belongs, based on the destination information acquired by the use information acquiring unit 451. That is, the driver information acquiring unit 452 specifies the destination of the user based on the destination information acquired by the use information acquiring unit 451. Referring to the driver database 441 stored in the storage unit 44, acquires driver information of a driver who resides in an area including the destination and has a vehicle in the area.

Areas in this case are defined within a predetermined range, for example, regardless of the area defined by the administrative compartment or the administrative compartment. For example, the area includes a prefecture, a municipality, a district, and a town name. Considering the point of revitalizing the area by increasing the tax revenue of the area including the destination, it is preferable that the area is defined by an administrative section such as a municipality, for example.

The vehicle associated with the area includes a vehicle belonging directly or indirectly to the area. The vehicle directly belonging to the area is, for example, a vehicle having a parking lot in the area. Specifically, the vehicle is a vehicle owned by a driver who resides in the area and parked in a parking lot of the place of residence.

A vehicle that belongs indirectly to an area means, for example, a vehicle that does not have a parking lot in the area but enters the area at least several times on a basis, such as one day, one week, or one month. More specifically, the term means a vehicle owned by a driver who resides in an area adjacent to the area or an area near the area and entering the area twice or more per day. Included are vehicles entering the area for shopping, commuting or schooling purposes, etc.

The driver information acquired by the use information acquiring unit 451 includes information on the current position of the vehicle of the driver. For example, the use information acquiring unit 451 identifies the vehicle that the driver has with reference to the driver database 441, and obtains information of the current position of the vehicle based on a signal from the GPS sensor 551 mounted on the vehicle. Assuming that the driver is riding in the vehicle, it is also possible to obtain information of the current position of the vehicle based on a signal from the GPS sensor 341 of the driver terminal 3.

The route calculating unit 453 calculates a traveling route (referred to as a first route) from the current position of the vehicle included in the driver information to the destination through the departure point instructed by the user. The route calculating unit 453 also calculates a traveling route (referred to as a second route) from the current position of the vehicle included in the driver information to the destination without going through the departure point instructed by the user. The second route corresponds, for example, to the return path when the driver returns to home without turning around.

The dispatch instructing unit 454 instructs the user of the vehicle associated with the area to perform vehicle dispatching based on the driver information acquired by the driver information acquiring unit 452. In this case, first, the dispatch instructing unit 454 acquires the position information of the vehicle associated with the area to which the destination belongs or the position information of the local driver having the vehicle acquired by the driver information acquiring unit 452, and the position information of the user. For example, the position information of the local driver and the position information of the user are acquired from the position information of the driver terminal 3 and the user terminal 2, respectively.

A ride share of the user by the driver's vehicle is enabled when the local driver is out using the vehicle. In consideration of this point, the local driver may be determined to be out using the vehicle by also obtaining the position information of the vehicle owned by the local driver and determining whether the driver terminal 3 and the in-vehicle terminal 5 are in the same position based on signals from the GPS sensors 341, 551.

Next, the dispatch instructing unit 454 determines whether or not the distance from the user to the local driver is within a predetermined value, based on the position information of the user (departure point information) and the driver information. The predetermined value is a distance suitable for performing ride share, and is set to, for example, about several km. A driver located within a predetermined value is a candidate for a driver to perform ride sharing. When it is determined that there are a plurality of local drivers whose distance from the user is within a predetermined value, the dispatch instructing unit 454 calculates the distances between the plurality of local drivers and the user, respectively, and proposes the ride share of the user to the local driver located closest to the user.

Specifically, the dispatch instructing unit 454 transmits the position information (departure point information) and the destination information of the user to the driver terminal 3 of the local driver or the in-vehicle terminal 5 of the vehicle of the local driver through the communication unit 41, thereby proposing the ride share. The proposal of the ride share is not limited to the local driver located closest to the user, but may be a local driver located in a place where it is easy to go to the user's position.

Upon receipt of a ride share proposal from the server device 4 along with the user's location and destination information, the local driver decides whether to accept the proposal. Then, the local driver inputs a response of ride share acceptance when accepting ride share, and inputs a response of ride share rejection when not accepting through the input unit 32. The input signal, that is, the response signal to the proposal of the ride share is transmitted to the server device 4 through the communication unit 31.

When a ride share acceptance signal is transmitted from the driver terminal 3, the dispatch instructing unit 454 transmits a matching establishment signal to the user terminal 2 of the user. When a signal indicating that matching is established is transmitted from the server device 4 to the user terminal 2, information indicating that matching is established is displayed on the output unit 23 of the user terminal 2. At this time, the user performs an operation of confirming the establishment of the matching through the input unit 22, and a signal corresponding to the operation is transmitted to the server device 4. As a result, the ride share reservation is fixed.

On the other hand, when a ride share disapproval signal is transmitted from the driver terminal 3, the dispatch instructing unit 454 selects a local driver located next near the user from a plurality of local drivers that are candidates for the ride share, and proposes the ride share to the selected local driver in the same manner as described above. The dispatch instructing unit 454 sequentially selects the local driver and repeats the proposal of the ride share until the matching is established.

The consideration calculating unit 455 calculates a consideration for transporting the user from the departure point to the destination. The consideration calculating unit 455 calculates a consideration in advance in accordance with the travel route (first route) calculated by the route calculating unit 453. For example, the distance along the first route is calculated, and the consideration is calculated in accordance with the distance. That is, the consideration is calculated so that the payment amount of the user becomes higher as the distance becomes longer. The consideration calculating unit 455 may calculate a travel time period estimated for the vehicle to travel along the first route, and calculate the consideration in accordance with the estimated travel time period. That is, the consideration may be calculated such that the longer the estimated travel time period, the higher the payment amount of the user. Regardless of the distance or the estimated travel time period, a fixed amount of consideration may be provided.

The consideration calculating unit 455 may calculate the consideration in consideration of not only the first route (R11, R12 or R21, R22 in FIG. 1) but also the second route (R10 or R20 in FIG. 1). For example, not only the distance at which the vehicle travels along the first route but also the distance at which the vehicle travels along the second route may be calculated, and the consideration may be calculated in accordance with the difference between these distances. Alternatively, not only the estimated travel time period for the vehicle to travel along the first route but also the estimated travel time period for the vehicle to travel along the second route may be calculated, and the consideration may be calculated in accordance with the difference between these time periods.

More specifically, the consideration when the vehicle travels along the second route R10 or R20 in FIG. 1 is calculated as the base consideration. Further, an additional consideration is calculated in accordance with a difference in distance between the first route R11, R12 or R21, R22 and the second route R10 or R20 or a difference in estimated travel time period. The additional consideration is added to the base consideration, and this is regarded as the consideration for Ride Share. In this case, the higher the difference in distance or the larger the difference in estimated travel time period, the higher the additional consideration. For example, since the vehicle 10B reaches the destination Y1 by detouring farther than the vehicle 10A, the extra charge for the driver 30B driving the vehicle 10B is higher than the extra charge for the driver 30A driving the vehicle 10A. As a result, when the drivers 30A and 30B go home away through the departure points X1 and X2 of the users 20A and 20B, the additional consideration is added in accordance with the degree of the go away, so that the satisfaction level of the drivers increases and the drivers can easily provide the ride share service.

The consideration information calculated by the consideration calculating unit 455 is transmitted to each of the user terminal 2 and the driver terminal 3, for example, when a ride share proposal is made. Thus, the user can determine whether or not to use the ride share in consideration of the payment amount, and the driver can determine whether or not to provide the ride share service in consideration of the reward amount. Note that the consideration calculating unit 455 may issue a discount coupon or the like that can be used near the destination to the user using the ride share service. The discount coupon may be such that the greater the consideration, the greater the discount amount or discount rate.

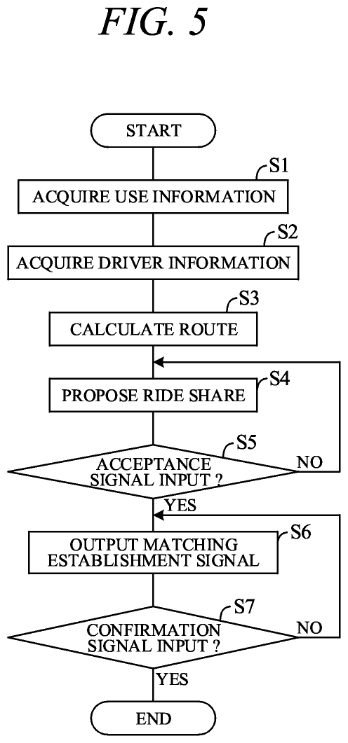

FIG. 5 is a flowchart showing an example of processing executed by the arithmetic unit 45 of the server device 4 in FIG. 4. The process of FIG. 5 starts, for example, when the server device 4 receives the use information transmitted from the user terminal 2.

As shown in FIG. 5, first, in S1 (S: processing Step), use information transmitted from the user terminal 2 is acquired. Next, in S2, driver information of the driver having the vehicle associated with the area to which the destination belongs is acquired based on the destination information included in the use information acquired in S1.

Next, in S3, a travel route in the case where each driver provides a ride share service is calculated based on the current position (departure point) and the destination of the user included in the use information acquired in S1, and the positions of the driver and the vehicle included in the driver information acquired in S2. Next, in S4, based on the travel route calculated in S3, a local driver who is out using the vehicle located closest to the user is selected. Then, it outputs a signal for proposing to perform the ride share service to the driver terminal 3 or the in-vehicle terminal 5 of the local driver. At this time, the consideration generated by the ride share is also calculated, and the information of the consideration is also output to the driver terminal 3 or the in-vehicle terminal 5.

Next, in S5, it is determined whether or not the ride share has been accepted by the driver, that is, whether or not the acceptance signal has been input, based on the response signal transmitted from the driver terminal 3 or the in-vehicle terminal 5 for which the ride share has been proposed. If the result in S5 is negative, the process returns to S4, and the same processing is performed for another local driver. On the other hand, if the result is affirmative in S5, the process proceeds to S6, and a matching establishment signal indicating that the matching has been established is output to the user terminal 2. At this time, the information of the consideration generated by the ride share is also output to the user terminal 2. Next, in S7, it is determined whether or not a confirmation signal for the ride share transmitted from the user terminal 2 is input. If the result is negative in S7, the process returns to S6, and if the result is positive, the process ends.

The present embodiment can achieve advantages and effects such as the following:

(1) The vehicle dispatch apparatus mainly configured by the server device 4 is configured to execute vehicle dispatching to the user in response to the travel instruction from the first point (departure point) to the second point (destination) instructed by the user (FIG. 1). The vehicle dispatch apparatus includes: a use information acquiring unit 451 for acquiring use information including destination information about a destination; a driver information acquiring unit 452 for acquiring driver information about a driver having a vehicle associated with an area to which the destination belongs based on the destination information acquired by the use information acquiring unit 451; and a dispatch instructing unit 454 for instructing to dispatch a vehicle associated with the area to the first point based on the driver information acquired by the driver information acquiring unit 452 (FIG. 4).

With this configuration, it is possible to travel to the destination using the vehicle associated with the destination. Therefore, with the increase in sales of drivers living in the region including the destination, the economy of the region including the destination becomes improved, and it is possible to contribute to the revitalization of the region. The user can drive to the destination with peace of mind because a local driver who is familiar with the road situation around the destination is driving, and can obtain useful information about the region until the user arrives at the destination through a conversation with the driver.

(2) The areas include areas defined by administrative zones. For example, the area may be a municipality defined by an administrative division. This makes it possible to contribute to the revitalization of local governments, such as municipalities, including destinations.

(3) The vehicle dispatch apparatus further includes: a route calculating unit 453 that calculates a travel route of the vehicle leading to the second point; and a consideration calculating unit 455 that calculates a consideration when the user is transported from the departure point to the destination in accordance with the travel route calculated by the route calculating unit 453 (FIG. 4). As a result, it is possible to appropriately give a consideration to the driver.

(4) The route calculating unit 453 calculates the first route R11 and R12 that reach the destination Y1 through the user's departure point X1, and a second route R10 that reaches the destination Y1 without passing through the departure point X1, as shown in FIG. 1. The consideration calculating unit 455 calculates the consideration in accordance with the distance difference between the first route R11, R12 and the second route R10, or the difference between the estimated travel time period required when the vehicle 10A travels along the first route R11, R12 and the estimated travel time period required when the vehicle 10A travels along the second route R10. As a result, since the higher the degree of detouring of the driver on the way home, the higher the consideration, the driver's satisfaction when providing the ride share service becomes higher and the use frequently of the ride share service becomes higher.

(5) The consideration calculating unit 455 calculates the base consideration in accordance with the distance from the departure point to the destination or the estimated travel time period required when the vehicle travels from the departure point to the destination. Further, an additional consideration to be added to the base consideration is calculated in accordance with the difference in distance between the first route and the second route or the difference in the estimated travel time period. This makes it possible to appropriately calculate the additional consideration.

(6) The vehicle associated with the area is a vehicle to which a parking space in the area is registered, or a vehicle entering the area more than a predetermined times (e.g., twice or more) within a predetermined time period (e.g., one day). This makes it possible to increase the number of drivers providing the ride share service, thereby making it easier to use the ride share service.

(7) The vehicles provided for the ride sharing service consist of a plurality of vehicles owned by a plurality of drivers. The driver information acquiring unit 452 further acquires the current positions of the plurality of vehicles of the plurality of drivers. The dispatch instructing unit 454 selects a vehicle nearest to the departure point of the user from among the plurality of vehicles acquired by the driver information acquiring unit 452, and instructs dispatching of the selected vehicle to the departure point. As a result, it is possible to execute dispatching in a short time in response to a request from the user.

(8) The ride share system 1 includes: a server device 4; a driver terminal 3 of the driver or an in-vehicle terminal 5 provided in a vehicle of the driver, which can communicate with the server device 4; and a user terminal 2 of the user, which can communicate with the server device 4 to input a travel instruction from a departure point to a destination (FIG. 2). Thus, the user can travel to the destination by using the vehicle associated with the destination.

In the above embodiment, the current position of the user at the time of applying for the use of the ride share service is set as the departure point, but the departure point is not limited to the current position of the user, and the user can arbitrarily designate the departure point. Therefore, the first point is not limited to the one described above. In the above embodiment, the case where the second point and the destination are the same has been described, but the second point and the destination may be different from each other. For example, when it is difficult for a vehicle to enter the second point due to a reason such as a traffic stop, a position corresponding to the second point (a position in the vicinity of the second point) may be used as a destination.

In the above embodiment, the use information acquiring unit 451 acquires the use information including the destination information, but the configuration of the destination information acquiring unit may be any configuration as long as the destination information is acquired. In the above embodiment, the driver terminal 3 of the driver and the in-vehicle terminal 5 provided in the vehicle of the driver are used as the driver terminals capable of communicating with the server device 4, but the driver terminals are not limited to those described above.

In the above embodiment, the vehicle dispatch apparatus is mainly configured by the server device 4, but a part or all of the functions of the vehicle dispatch apparatus may be included in a terminal other than the server device 4, for example, the in-vehicle terminal 5.

The above embodiment can also be configured as a vehicle dispatch method for executing vehicle dispatch for a user in response to a travel instruction from a first point to a second point instructed by the user. In this case, the configuration may include: acquiring destination information about a destination corresponding to the second point; acquiring driver information about a driver having a vehicle associated with an area to which the destination belongs based on the acquired destination information; and instructing to dispatch the vehicle associated with the area to the first point based on the acquired driver information.

The above embodiment can be combined as desired with one or more of the above modifications. The modifications can also be combined with one another.

According to the present invention, it becomes possible to travel to the destination by using the vehicle associated with the destination.

Above, while the present invention has been described with reference to the preferred embodiments thereof, it will be understood, by those skilled in the art, that various changes and modifications may be made thereto without departing from the scope of the appended claims.

What is claimed is:

1. A vehicle dispatch apparatus configured to execute vehicle dispatch for a user in response to a travel instruction from a first point to a second point instructed by the user, comprising:
an electronic control unit having a CPU and a memory, wherein
the CPU is configured to perform:
acquiring a destination information about a destination corresponding to the second point;
acquiring a driver information about a driver owning a vehicle associated with an area including the destination based on the destination information acquired; and
instructing dispatch of the vehicle associated with the area to the first point based on the driver information acquired.

2. The vehicle dispatch apparatus according to claim 1, wherein
the area includes an area defined by administrative zones.

3. The vehicle dispatch apparatus according to claim 1, wherein
the CPU is configured to perform:
calculating a travel route of the vehicle to the second point; and
calculating a consideration for transporting the user from the first point to the second point based on the travel route calculated.

4. The vehicle dispatch apparatus according to claim 3, wherein
the CPU is configured to perform:
the calculating the travel route including:
calculating a first route to the second point passing through the first point and a second route to the second point without passing through the first point; and
the calculating the consideration including:
calculating the consideration based on a difference in travel distances of the first route and the second route or a difference in travel time periods estimated for the vehicle to travel along the first route and the second route.

5. The vehicle dispatch apparatus according to claim 4, wherein
the CPU is configured to perform:
the calculating the consideration including:
calculating a base consideration based on a travel distance from the first point to the second point or a travel time period estimated for the vehicle to travel from the first point to the second point; and
calculating an additional consideration added to the base consideration based on the difference in travel distances or the difference in travel time periods.

6. The vehicle dispatch apparatus according to claim 1, wherein
the vehicle associated with the area is a vehicle to which a parking space in the area is registered or a vehicle entering the area more than a predetermined times within a predetermined time period.

7. The vehicle dispatch apparatus according to claim 1, wherein
the vehicle is a plurality of vehicle respectively owned by a plurality of driver, wherein
the CPU is configured to perform:
the acquiring the driver information including acquiring a current position of each of the plurality of vehicle; and
the instructing dispatch including:
selecting a vehicle nearest to the first point from among the plurality of vehicle acquired; and
instructing dispatch of the vehicle selected to the first point.

8. A vehicle dispatch system, comprising:
the vehicle dispatch apparatus according to claim 1;
a driver terminal carried by a driver or mounted on a vehicle owned by the driver and configured to be able to communicate with the vehicle dispatch apparatus; and
a user terminal carried by a user and configured to be able to communicate with the vehicle dispatch apparatus to input a travel instruction from the first point to the second point.

9. A vehicle dispatch method for executing vehicle dispatch for a user in response to a travel instruction from a first point to a second point instructed by the user, comprising:
acquiring a destination information about a destination corresponding to the second point;
acquiring a driver information about a driver owning a vehicle associated with an area including the destination based on the destination information acquired; and
instructing dispatch of the vehicle associated with the area to the first point based on the driver information acquired.
